(19) United States
(12) Patent Application Publication
(10) Pub. No.: US 2005/0190118 A1
(43) Pub. Date: Sep. 1, 2005

(54) Method for driving display panel

(76) Inventors: Eun Sik Ryu, Seoul (KR); Yong Seob Shin, Kyoungki-do (KR)

Correspondence Address: LADAS & PARRY LLP, 224 SOUTH MICHIGAN AVENUE, SUITE 1600, CHICAGO, IL, 60604, US

(21) Appl. No.: 11/030,745

(22) Filed: Dec. 15, 2004

(30) Foreign Application Priority Data
Feb. 27, 2004 (KR) 2004-13305

(51) Int. Cl. G09G 3/20

(52) U.S. Cl. 345/58

(57) ABSTRACT

Disclosed is a method for driving a display panel capable of removing a chromatic difference, and a flicker or cross-talk phenomenon caused by a gate signal line delay and a polarity inverse control signal generated between lines by inversing a polarity while shifting a polarity control signal in each line. The method includes the steps of dividing a gate signal line into a plurality of groups aligned with a uniform interval and repeatedly inversing a polarity of each frame according to an activation of the gate signal line of each group in response to a shift polarity inverse control signal.

### BACKGROUND OF THE INVENTION

1. Field of the Invention

The present invention relates to a display panel, and more particularly to a method for driving a display panel by inversing a frame every four lines while shifting a polarity control signal.

2. Description of the Prior Art

A shift polarity inverse control is employed in order to compensate for a data difference between lines when an N^{th} line inverse is carried out through an FPGA (field programmable gate array) or an ASIC. In addition, according to an FSC (field sequential color) technology, a color is reproduced by using an LED, instead of a color filter, so the FSC technology is mainly used for moving pictures or for products having a small size, such as portable phones.

Conventionally, a polarity is not shifted, but an N^{th} polarity inverse control is used in match with an N^{th} line inverse. When the N^{th} polarity inverse control is used in the FSC technology, a chromatic difference is generated between lines. In addition, although a gate ON voltage applied to a first terminal is identical to a waveform applied thereto, a waveform of a gate ON voltage applied to a final terminal is delayed depending on characteristics of a gate signal line metal due to a gate signal line delay. That is, due to the gate signal line delay, data for a next pixel is unnecessarily applied to a current operated pixel. Thus, when a thin film transistor LCD is displayed, a flicker and cross-talk phenomenon may be created due to the gate signal line delay.

### SUMMARY OF THE INVENTION

Accordingly, the present invention has been made to solve the above-mentioned problems occurring in the prior art, and an object of the present invention is to provide a method for driving a display panel capable of removing a chromatic difference and a flicker or cross-talk phenomenon caused by a gate signal line delay and a polarity inverse control signal generated between lines by inversing a polarity while shifting a polarity control signal in each line.

In order to accomplish this object, there is provided a method for driving a display panel, the method comprising the steps of: dividing a gate signal line into a plurality of groups aligned with an uniform interval, and repeatedly inversing a polarity of each frame according to an activation of the gate signal line of each group in response to a shift polarity inverse control signal.

### BRIEF DESCRIPTION OF THE DRAWINGS

The above object, features and advantages of the present invention will be more apparent from the following detailed description taken in conjunction with the accompanying drawings, in which:

FIG. 1 is a view for explaining a method of driving a display panel according to one embodiment of the present invention;

FIG. 2 is a view showing a waveform of a signal representing a frame inverse according to one embodiment of the present invention;

FIG. 3 is a view for explaining a frame inverse method according to one embodiment of the present invention;

FIG. 4 is a view showing a screen image displayed through a conventional method for driving a display panel; and

FIG. 5 is a view showing a screen image displayed through a method for driving a display panel according to one embodiment of the present invention.

### DETAILED DESCRIPTION OF THE PREFERRED EMBODIMENTS

Hereinafter, a preferred embodiment of the present invention will be described with reference to the accompanying drawings.

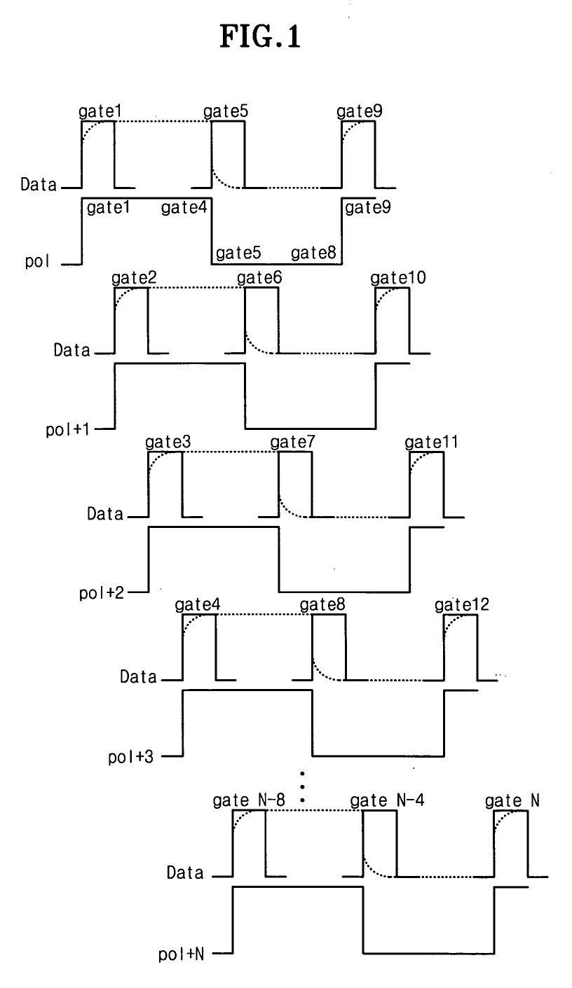

FIG. 1 is a view for explaining a method of driving a display panel according to one embodiment of the present invention.

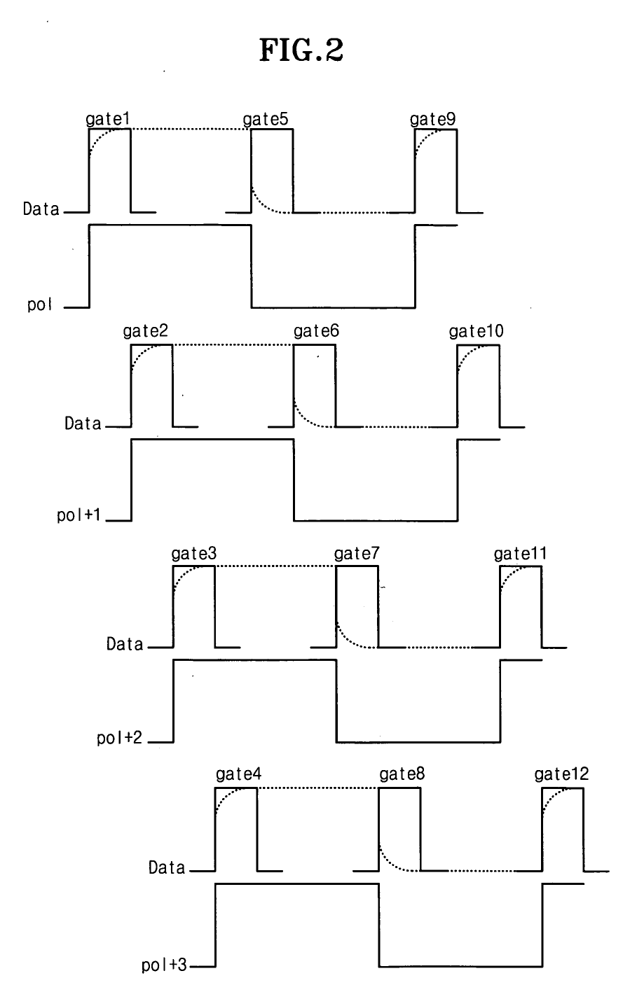

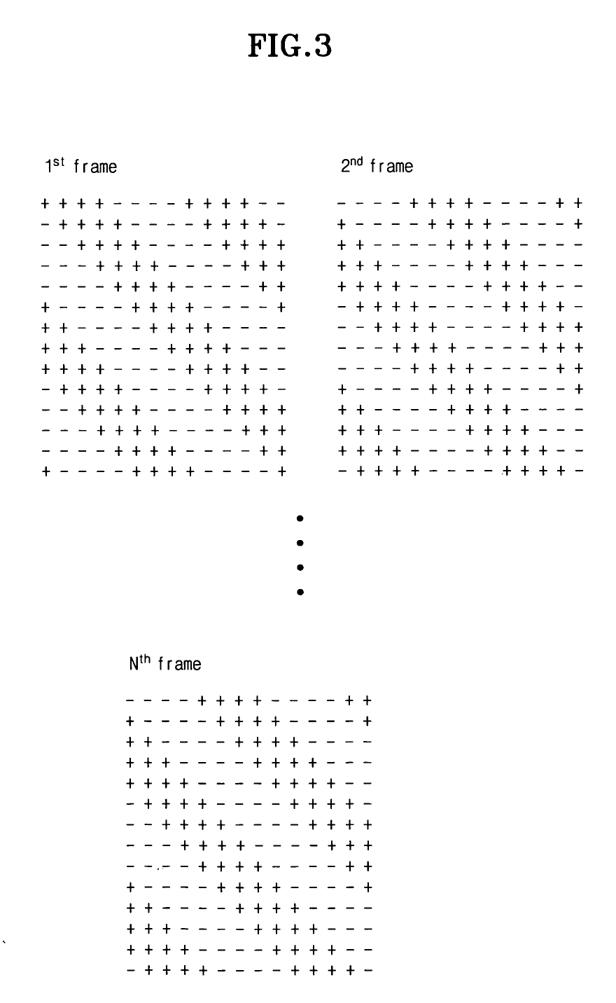

Referring to FIG. 1, in order to remove a brightness difference or a chromatic difference between lines caused by a gate signal line delay, a polarity control signal is shifted while shifting a polarity every four lines. FIG. 2 is a view showing a waveform of a signal representing a frame inverse according to one embodiment of the present invention. FIG. 3 is a view for explaining a frame inverse method according to one embodiment of the present invention.

In order to compensate for a data difference between adjacent lines caused by a line inverse, a display panel is driven while shifting a polarity inverse control signal, thereby ensuring a margin of a data filling time according to the polarity inverse control in an FSC. Accordingly, an image quality can be improved, and the chromatic difference between lines can be removed, thereby solving problems caused by the gate signal line delay.

Hereinafter, a four-line inverse method will be explained. The four-line inverse method signifies that a polarity is shifted every four gate signal lines whenever a frame is changed. According to the conventional manner, the polarity control signal is not shifted, but a polarity of the frame is shifted whenever the frame is changed. However, according to the present invention, the polarity control signal is shifted whenever the frame is changed, and, when reaching an N^{th} gate, the polarity of a first gate line of a next gate is changed. In this manner, the chromatic difference between lines, and the flicker or cross-talk phenomenon can be removed, so the image quality of a display unit having a small size, such as an LCD or a cellular phone, can be improved.

The gate signal line is divided into three gate groups having four gates, respectively. As shown in FIG. 1, the polarity is changed whenever the polarity control signal is inversed, so the chromatic difference is generated between a previous gate signal line and a next gate signal line about a gate signal line, in which the polarity control signal is inversed, thereby causing the flicker or the cross-talk phenomenon. Such a problem is inevitable if a liquid crystal has no rapid response speed.

Accordingly, in order to solve the problem shown in FIG. 1, the shift polarity inverse method is employed. That is, as shown in FIGS. 2 and 3, in a first frame, a first gate signal line and 4n^{th} gate lines of the first gate signal line are activated so that the polarity is changed at the first gate signal line, a fifth gate signal line, a ninth gate signal line and a thirteenth gate signal line. In addition, in a second frame, a second gate signal line and 4n^{th} gate lines of the second gate signal line are activated so that the polarity is changed at the second gate signal line, a sixth gate signal line, a tenth gate signal line and a fourteenth gate signal line. In a third frame, a third gate signal line and 4n^{th} gate lines of the third gate signal line are activated so that the polarity is changed at the third gate signal line, a seventh gate signal line, an eleventh gate signal line and a fifteenth gate signal line.

Thus, the chromatic difference between the previous gate signal line and the next gate signal line, and the flicker or cross-talk phenomenon can be significantly removed by repeating the above procedure. However, if the above procedure is constantly repeated, the polarity is biased to one side. Accordingly, in order to prevent the polarity from being biased to one side, in a final N^{th} gate, a shift polarity of a next (N+1)^{th} gate is inversed, thereby compensating for the chromatic difference between the previous gate signal line and the next gate signal line, and attenuating the flicker or cross-talk phenomenon.

FIG. 2 is a view representing a polarity of a frame when illustrating FIG. 1 with polarity. Since the polarity between frames is changed whenever the frame is changed, the chromatic difference or brightness difference between lines, and the flicker or cross-talk phenomenon can be removed.

According to the present invention, in a display panel having a screen image in the form of an active matrix and small products, such as portable telephones, a source driver IC (not shown) and a gate driver IC (not shown) are operated by receiving control signals from an FSC driven by an LED and a timing controller (not shown) and a gate ON/OFF signal from a power source, in such a manner that the display panel can be driven by means of signals provided from the source driver IC and the gate driver IC. That is, the display panel is driven by means of signals provided from the source driver IC and the gate driver IC by using a shift polarity control signal outputted from the timing controller. In addition, according to the present invention, the shift polarity control signal is generated based on an N^{th} line inverse and the frame is inversed by means of the shift polarity control signal, thereby driving the display panel.

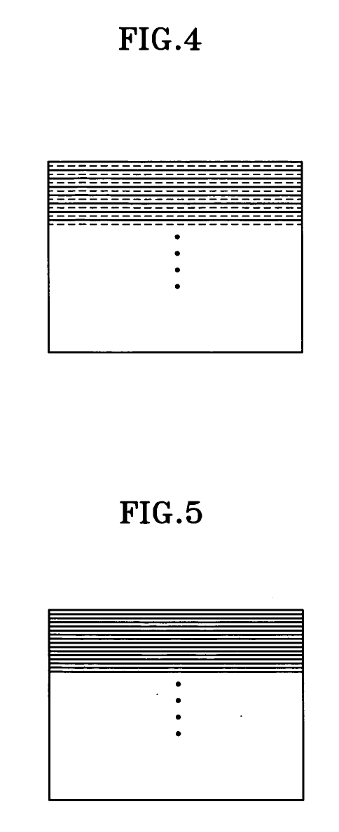

FIG. 4 is a view showing a screen image displayed through a conventional display panel driving method, and FIG. 5 is a view showing a screen image displayed through a display panel driving method according to one embodiment of the present invention.

As is understood from FIGS. 4 and 5, an image represented by the display panel driving method according to the present invention is superior to an image represented by the conventional display panel driving method.

Therefore, according to the present invention, the chromatic difference between lines or a flicker and cross-talk phenomenon caused by a gate signal line delay and a polarity inverse can be removed by using a shift polarity inverse. That is, if the polarity is inversed while shifting the polarity every line, problems caused by the chromatic difference between lines, such as the chromatic difference between lines, and the flicker or cross-talk phenomenon exerting a bad influence on an image quality can be removed. Although the prior art also inverses the polarity, the polarity is not shifted.

However, according to the present invention, the polarity control signal is shifted while inversing the polarity control signal between frames, so that the flicker or cross-talk phenomenon caused by the brightness difference or the chromatic difference generated between lines whenever an N^{th} line inverse is performed can be removed. That is, since the polarity is shifted, problems generated between adjacent lines can be removed.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A method for driving a display panel, the method comprising the steps of:
i) dividing a gate signal line into a plurality of groups aligned with an uniform interval; and
ii) repeatedly inversing a polarity of each frame according to an activation of the gate signal line of each group in response to a shift polarity inverse control signal.

2. The method according to claim 1, wherein, when reaching a final gate signal line of one group, the polarity of the shift polarity control signal is inversed in a first gate signal line of a next group so as to again shift the shift polarity control signal.

3. The method according to claim 1, wherein step i) includes a step of dividing the gate signal line into three groups having four line intervals, and step ii) includes the substeps of inversing a polarity of a first frame according to an activation of the first gate signal line and 4n^{th} gate signal lines of the first gate signal line, inversing a polarity of a second frame according to an activation of a second gate signal line and 4n^{th} gate signal lines of the second gate signal line, and inversing a polarity of a third frame according to an activation of a third gate signal line and 4n^{th} gate signal lines of the third gate signal line.
